(19) United States
(12) Patent Application Publication
(10) Pub. No.: US 2010/0257388 A1
(43) Pub. Date: Oct. 7, 2010

(54) PHASE SHEDDING IN A MULTI-PHASE REGULATOR

(76) Inventors: Alan M. Green, Tomball, TX (US); Reza M. Bacchus, Spring, TX (US); Binh Nguyen, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/416,523

(22) Filed: Apr. 1, 2009

(51) Int. Cl. G06F 1/32

(52) U.S. Cl. 713/320

(57) ABSTRACT

A method for phase shedding is disclosed. The method comprises the following steps. At step one power is supplied to a memory sub-system with a multi-phase regulator wherein a maximum number of phases in the multi-phase regulator are enabled. At step two the memory configuration of the memory sub-system is determined. At step three at least one of the phases of the multi-phase regulator is disabled when the memory configuration meets a predetermined criteria.

### BACKGROUND

Large computer systems typically contain a number of sub-systems, for example memory sub-systems. These memory sub-systems can be configured with different amounts of memory. The amount of memory in a memory sub-system may be changed by adding or removing memory boards or memory integrated circuits (ICs) from the memory sub-system. The amount of current required by the memory sub-system varies depending on how much memory the memory sub-system contains. The memory sub-systems may be powered by multi-phased regulators.

Multi-phased regulators can supply different amounts of current to a sub-system depending on how many phases of the multi-phase regulator are enabled. The current level at which the regulator reaches its peak efficiency also varies depending on how many phases of the multi-phase regulator are enabled. Typically, as the enabled number of phases increases, the amount of the current required to reach peak efficiency also increases. When all the phases in the regulator are enabled, the current must be near its maximum for the regulator to be operating near its peak efficiency.

### BRIEF DESCRIPTION OF THE DRAWINGS

FIG. 1 is a computer system 100 in an example embodiment of the invention.

FIG. 2 is a table listing the maximum current for possible-memory configurations of a memory sub-system in an example embodiment of the invention.

FIG. 3 is a flow chart for phase shedding in an example embodiment of the invention.

### DETAILED DESCRIPTION

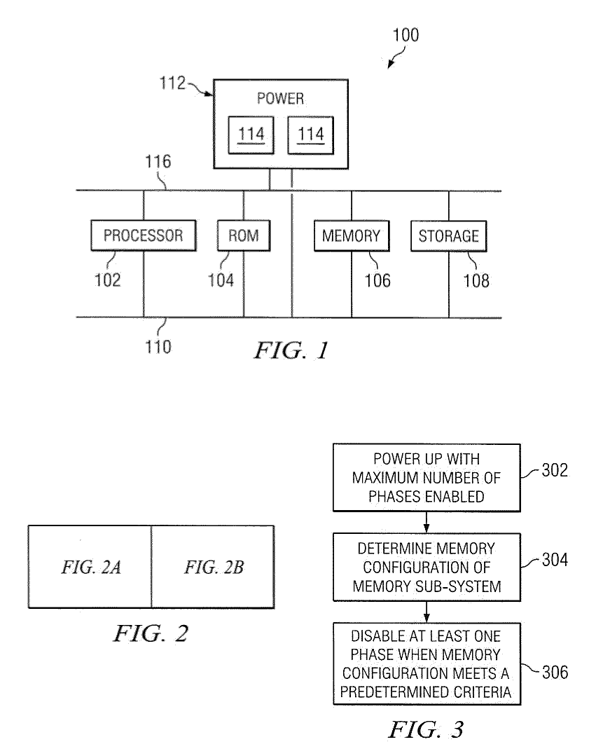

FIGS. 1-3, and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a block diagram of a computer system 100 in an example embodiment of the invention. Computer system 100 comprises a number of components including processor 102, Read Only Memory (ROM) 104, memory sub-system 106, storage sub-system 108, and power system 112. Processor 102 is coupled to ROM 104, memory sub-system 106, storage sub-system 108, and power system 112 by interlinking bus or fabric 110. Interlinking bus or fabric 110 may be an type of link used to couple two or more devices together, for example a parallel bus, point-to-point links, optical links, or the like. Power system 112 is coupled to processor 102, ROM 104, memory sub-system 106, and storage sub-system 108 by power bus 116.

Processor 104 may comprise one or more central processing units (CPU's), one or more servers, micro-computers, blades, super computers, or the like. Memory sub-system 106 may comprise one or more memory controllers and a plurality of memory boards or memory integrated circuits (ICs), for example dual inline memory modules (DIMMs). Storage sub-system 108 may comprise a storage controller and one or more non-volatile storage devices, for example disc drives. Power system 112 may comprise a plurality of multi-phase regulators 114. Using power bus 116, each of the plurality of multi-phase regulators 114 may be coupled to, and supply power to, one or more of the computer system components. The processor 102 can enable or disable phases in the multi-phase regulators 114 by sending a signal or flag, across interconnecting fabric or bus 110, to power system 112.

The amount of current required by memory sub-system 106 depends on how much memory the memory sub-system contains. The amount of memory contained in memory sub-system can be changed over time by adding or removing memory boards or memory integrated circuits (ICs) from the memory sub-system. During the boot process, the memory configuration of memory sub-system 106 can be determined.

When power is first supplied to a computer system, the computer system typically goes through a boot process. At power on, the processor 102 typically loads a Basic Input/Output System (BIOS) from a non-volatile memory store, for example ROM 104. Using BIOS the processor will typically initialize the other hardware components and then load an operating system from storage sub-system 108 into memory sub-system 106. During hardware initialization, the configuration of the memory sub-system may be determined.

To determine the memory configuration, the BIOS will query the memory sub-system across interlinking bus or fabric 110. The memory configuration may comprise the type of memory installed (registered or unbuffered), the width of the dynamic random access memory (DRAM) integrated circuits (IC's) installed, and the number of ranks of Dual Inline Memory Modules (DIMM) installed. The memory sub-system must be powered up for the processor to determine the current memory configuration of the memory sub-system.

When power is first supplied to computer system 100, the memory configuration of memory sub-system 106 is unknown. If memory sub-system 106 is fully loaded, memory sub-system 106 may require full power (near maximum current) from the multi-phase regulator 114 supplying power to memory sub-system 106. Therefore, at power up, the multi-phase regulator 114 coupled to memory sub-system 106 will have a sufficient number of phases enabled to deliver the maximum possible current required by memory sub-system 106. For example, if the maximum possible current required by a fully loaded memory sub-system is 75 amps, and each phase of multi-phased regulator 114 could supply 25 amps, then at least three phases in multi-phased regulator 114 would be enabled at power up. The maximum current for memory sub-system 106 may vary depending on the total number of DIMMs that can be loaded and the type of DRAMs used. For example, some fully loaded memory sub-systems may only require 47 amps while other fully loaded memory sub-systems may require 97 amps.

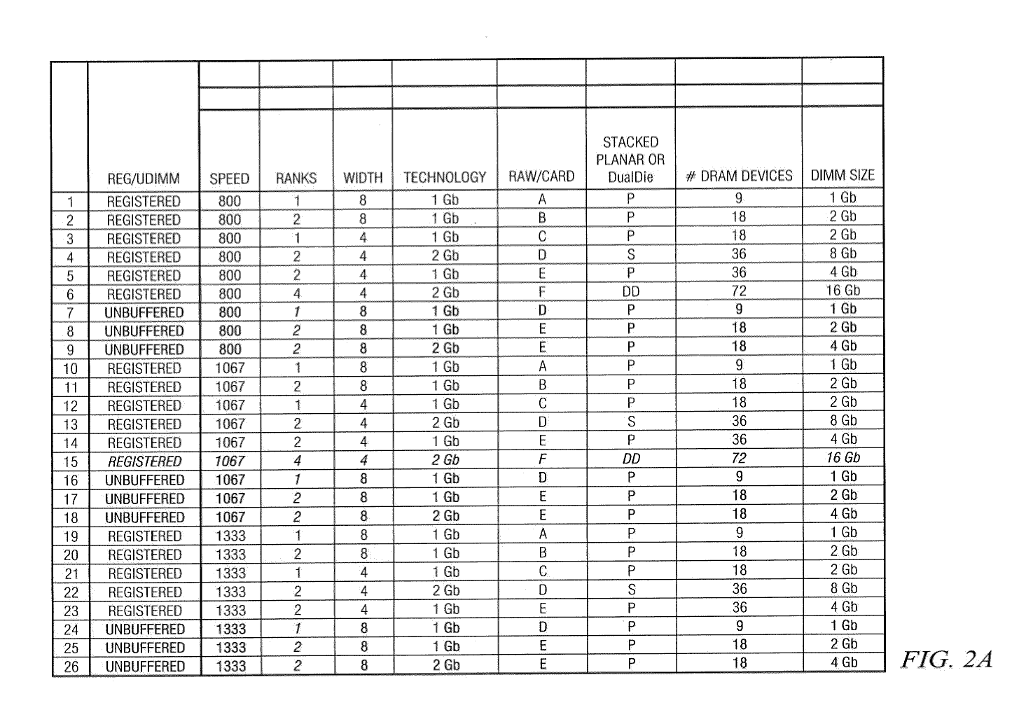

Once the memory configuration has been determined, the maximum current required by the memory sub-system in its current configuration can be determined. FIG. 2 is a table listing the maximum current for possible memory configurations of a memory sub-system in an example embodiment of the invention. Each row in the table is a possible memory configuration for the memory subsystem. The columns in the section labeled “1.5V Current(A) per node” show the current required for the memory configuration using 1, 2 or 3 DIMMs per channel at three different refresh rates. For example, row 4 shows that the maximum current required by a memory sub-system using 36 Registered 800 speed DRAMs with 2 ranks of 4 bit wide 2 Gigabyte technology having 2 DIMMs per channel with the fastest refresh rate is 29.4 amps.

In one example embodiment of the invention, a table similar to FIG. 2 may be stored in memory. Once the memory configuration for the memory sub-system has been determined at power up, the maximum current for the loaded memory configuration can be determined using the table. In another example embodiment of the invention, the information in the table may be generalized into a simple set of tests or a simple equation. For example, looking at the table in FIG. 2, it can be determined that all unbuffered, fully populated configurations consume less than 25 amps.

It can also be determined that no configuration with 108 or fewer DRAM devices consumes more than 25 amps. For example, row 13 is for registered, 1067 speed, 36 DRAM devices, 8 Gigabyte memory modules (DIMMs). Three of these DIMM memory modules installed is equivalent to 1 DIMM per channel in the table, showing 20.4 amps at maximum refresh rate (Item 202). The three DIMM memory modules will contain (36)*(3)=108 DRAM devices. If you move to the 2 DIMMs per channel column (Item 204), the maximum current is 36.5 amps, but this is with 6 DIMMs (or 216 DRAMs). The maximum current for any memory configuration in the table is 56.7 amps.

In one example embodiment of the invention, the multi-phase regulator is an International Rectifier using an IR3513 controller with four IR308 phases. Each enabled IR308 phase can supply 25 amps of current. With three phases enabled, the multi-phase regulator can supply up to 75 amps, which is well above the maximum fully loaded current draw of 56.7 amps. Therefore, in one example embodiment of the invention, the multi-phase regulator will have three phases enabled at power-up.

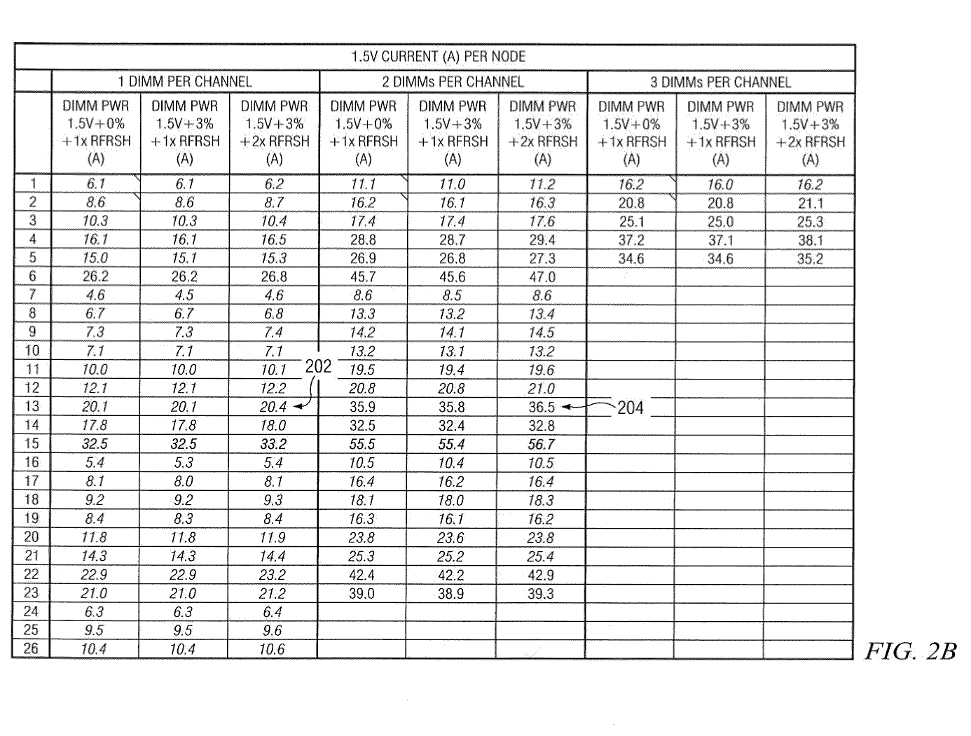

Once the memory configuration of memory sub-system has been determined, the number of enabled phases in multi-phase regulator 114 can be adjusted to match the memory configuration. FIG. 3 is a flow chart for phase shedding in an example embodiment of the invention. At step 302, the multi-phase regulator is powered up with a maximum number of phases enabled. The maximum number of phases enabled corresponds to the number of phase required to supply the maximum possible current to the memory sub-system. At step 304 the memory configuration of the memory sub-system is determined. At step 306 at least one enabled phase of the multi-phase regulator is disabled (or shed) when the memory configuration meets a predetermined criteria.

The predetermined criteria may correspond to a memory configuration that requires a maximum current less than the current supplied with fewer than the maximum number of phases enabled. For example, if three phases of a multi-phased regulator are enabled at power up, and each phase supplies up to 25 amps, then a memory configuration that requires less than 50 amps would meet the predetermined criteria.

In one example embodiment of the invention, when the memory sub-system is unbuffered then the memory configuration meets the predetermined criteria. Or when the memory sub-system is buffered and when there are 2 Dual Inline Memory Modules (DIMMs) mounted on the memory sub-system, then the memory configuration meets the predetermined criteria. Or when the memory sub-system is buffered and when there are less than 109 Dynamic Random Access memory (DRAM) integrated circuits mounted on the memory sub-system, then the memory configuration meets the predetermined criteria. In this example embodiment, when the memory configuration meets the predetermined criteria, the maximum current drawn by the memory sub-system will be less than 25 amps. Therefore all but one phase in the multi-phase regulator will be disabled.

What is claimed is:

1. A method for phase shedding in a computer system, comprising:
supplying power to a memory sub-system with a multi-phase regulator wherein a maximum number of phases in the multi-phase regulator are enabled;
determining a memory configuration of the memory sub-system;
disabling at least one of the enabled phases of the multi phase regulator when the memory configuration meets a predetermined criteria.

2. The method for phase shedding of claim 1, wherein the memory configuration is based on a number of devices coupled to the memory sub-system.

3. The method for phase shedding of claim 2 wherein the number of devices coupled to the memory sub-system determines a maximum current used by the memory sub-system.

4. The method for phase shedding of claim 1, wherein the memory configuration is determined by a Basic Input/Output System (BIOS) during the computer system's power-up process.

5. The method for phase shedding of claim 1, wherein the memory sub-system is configured to mount a plurality of Dual Inline Memory Modules (DIMMs).

6. The method for phase shedding of claim 1, wherein:
when the memory in the memory sub-system is unbuffered then the memory configuration meets the predetermined criteria; or
when the memory in the memory sub-system is buffered and when there are 2 Dual Inline Memory Modules (DIMMs) mounted in the memory sub-system, then the memory configuration meets the predetermined criteria; or
when the memory in the memory sub-system is buffered and when there are less than 109 Dynamic Random Access memory (DRAM) integrated circuits mounted in the memory sub-system, then the memory configuration meets the predetermined criteria.

7. The method for phase shedding of claim 1, wherein when the memory configuration meets the predetermined criteria all but one phase in the multi-phase regulator are disabled.

8. The method for phase shedding of claim 1, wherein the maximum number of phases enabled is 3.

9. A computer system, comprising:
at least one processor;
a memory sub-system coupled to the processor;
a power system coupled to the at least one processor, the power system comprising at least one multi-phase regulator, wherein the at least one multi-phase regulator is coupled to, and supplies current to, the memory sub-system;
code, loaded on a computer readable medium, that when executed by the processor causes the processor to execute a method for phase shedding comprising:
enabling a maximum number of phases in the at least one multi-phase regulator such that power is supplied to the memory sub-system;
determining a memory configuration of the memory sub-system;
disabling at least one of the enabled phases of the multi-phase regulator when the memory configuration meets a predetermined criteria.

10. The computer system of claim 9, wherein the memory configuration is based on a number of devices coupled to the memory sub-system.

11. The computer system of claim 10 wherein the number of devices coupled to the memory sub-system determines a maximum current used by the memory sub-system.

12. The computer system of claim 9, wherein the memory configuration is determined by a Basic Input/Output System (BIOS) during the computer system's power-up process.

13. The computer system of claim 9, wherein:
when the memory in the memory sub-system is unbuffered then the memory configuration meets the predetermined criteria; or
when the memory in the memory sub-system is buffered and when there are 2 Dual Inline Memory Modules (DIMMs) mounted in the memory sub-system, then the memory configuration meets the predetermined criteria; or
when the memory in the memory sub-system is buffered and when there are less than 109 Dynamic, Random Access memory (DRAM) integrated circuits mounted in the memory sub-system, then the memory configuration meets the predetermined criteria.

14. The computer system of claim 9, wherein when the memory configuration meets the predetermined criteria all but one phase in the multi-phase regulator are disabled.

15. The computer system of claim 9, wherein the maximum number of phases enabled is 3.
